(19) United States
(12) Patent Application Publication
(10) Pub. No.: US 2005/0000224 A1
(43) Pub. Date: Jan. 6, 2005

(54) Gas turbine arrangement

(75) Inventor: Bertil Jonsson, Bjarred (SE)

Correspondence Address: TRACY W. DRUCE, ESQ., 1496 EVANS FARM DR, MCLEAN, VA, 22101, US

(73) Assignee: Volvo Aero Corporation, Trollhattan (SE)

(21) Appl. No.: 10/709,650

(22) Filed: May 19, 2004

Related U.S. Application Data
(63) Continuation of application No. PCT/SE02/01831, filed on Oct. 8, 2002.

(30) Foreign Application Priority Data
Nov. 19, 2001 (SE) 0103842-1

(51) Int. Cl. F02C 7/36

(52) U.S. Cl. 60/793

(57) ABSTRACT

A gas turbine arrangement (1) including a gas turbine (2), a generator (3) and a gearbox (4). The gearbox (4) is connected to an output shaft (5) from the gas turbine and an input shaft (6) to the generator. The gas turbine arrangement (1) also has a starter motor (7) that is connected to an output shaft (8) from the generator (3).

### CROSS-REFERENCE TO RELATED APPLICATIONS

The present application is a continuation patent application of International Application No. PCT/SE02/01831 filed 8 Oct. 2002 which was published in English pursuant to Article 21(2) of the Patent Cooperation Treaty, and which claims priority to Swedish Application No. 0103842-1 filed 19 Nov. 2001. Both applications are expressly incorporated herein by reference in their entireties.

### TECHNICAL FIELD

The present invention relates to a gas turbine arrangement comprising (including, but not limited to) a gas turbine, a generator and a gearbox, the gearbox being connected to an output shaft from the gas turbine and an input shaft to the generator.

### BACKGROUND ART

In the context of the present invention, the term gas turbine has been utilized to mean a device which comprises at least a turbine and a compressor, and also a combustion chamber. The gas turbine is primarily intended for, and will be described below with respect to applications in power stations for electricity production. Gas turbines of this type, however, can also be used in other applications such as for the propulsion of vehicles, aircraft and vessels.

The gearbox includes a main gear which is intended to reduce the high speed of the output shaft of the gas turbine to a suitable generator speed, usually 1500 or 1800 rpm. An auxiliary apparatus gear for driving auxiliary apparatuses such as a starter motor, oil pump, fuel pump, rotating oil separator and compressors is also usually included in the gearbox. The auxiliary apparatus drive conventionally takes place utilizing toothed gearings which are driven from one of the gearwheels of the main gear.

Owing to the great speed differences which are present between the operating speed of the gearwheels of the main gear and the speeds which are suitable for most auxiliary apparatuses, the auxiliary apparatus gear usually comprises a relatively complicated system of a large number of gearwheels with associated bearings, bearing housings and the like. An auxiliary apparatus drive arranged in this way means that the gearbox has a very complicated construction in relation to the main gear, and the gearbox is thus also expensive to manufacture.

### DISCLOSURE OF INVENTION

One objective of the invention is to provide a gas turbine arrangement that is more cost-effective to manufacture in relation to the prior art.

This object is achieved by virtue of the fact that the gas turbine arrangement comprises a starter motor which is connected to an output shaft from the generator. The starter motor is therefore arranged on another side of the generator relative to the gearbox. By arranging the starter motor in this way, the construction of the gearbox can be simplified considerably. Furthermore, the freedom of choice to use different types of starter motors (electric, hydraulic or pneumatic starter motors) is greater because the starter motor is arranged separately on the output shaft of the generator.

Moreover, mounting and accessibility for service of the starter motor are simplified.

According to a preferred embodiment of the invention, the gas turbine arrangement comprises at least one auxiliary apparatus which, for driving, is connected to an external energy source. In other words, the auxiliary apparatus is driven not from the rotating parts of the gas turbine arrangement, more specifically not from the gearbox, but instead from a separate energy source, such as an electric motor. This means that the construction of the gearbox can be further simplified.

According to another preferred embodiment of the invention, which is an alternative or complement to the preceding embodiment, the gearbox consists of a planetary gearbox and the gas turbine arrangement comprises at least one auxiliary apparatus which, for driving, is connected to a planet wheel shaft of the planetary gearbox. In this way, the auxiliary apparatus can therefore be driven from the planet wheel shaft instead of from the auxiliary apparatus gearbox which affords an opportunity to reduce the number of gearwheels in the transmission for driving the auxiliary apparatus. Some auxiliary apparatuses are particularly suitable for being driven at speeds as high as the planet wheels in operation. Examples of such auxiliary apparatuses are the oil pump and the rotating oil separator.

According to another preferred embodiment of the invention, the speed of the starter motor is adjustable. When use is made of fuel in gaseous form, there are often provisions that the gas turbine is to be ventilated before each start. The rotating parts of the gas turbine are then to be rotated at a low speed, what is known as ventilation speed. After ventilation has been completed, the gas turbine is started, and use is then made of a considerably higher speed.

### BRIEF DESCRIPTION OF THE DRAWINGS

The invention will be described in greater detail below with reference to the embodiments shown in the accompanying drawings, and in which:

FIG. 1 diagrammatically shows component parts of the gas turbine arrangement;

FIG. 2 diagrammatically shows the gas turbine, in a partly sectional view, according to a first embodiment;

FIG. 3 diagrammatically shows, in a side view, the coupling of the starter motor to the gas turbine arrangement according to a second embodiment; and

FIG. 4 diagrammatically shows, in a side view, the coupling of an auxiliary apparatus of the gas turbine arrangement according to a third embodiment.

### MODE FOR THE INVENTION

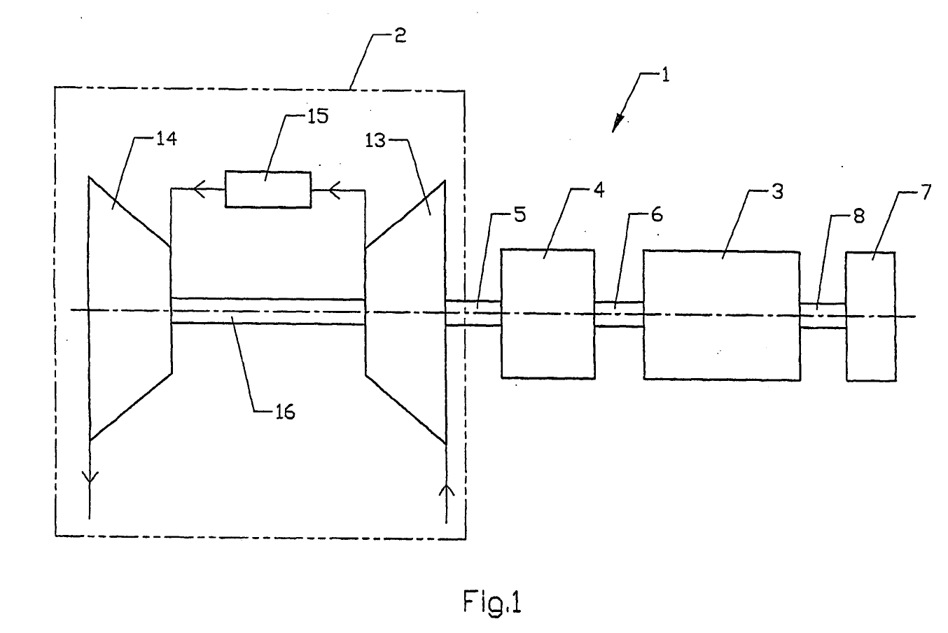

FIG. 1 shows a gas turbine arrangement 1 configured according to a first embodiment of the present invention. The gas turbine arrangement 1 comprises a gas turbine 2, a generator 3 and a gearbox 4 arranged between the gas turbine 2 and the generator 3. To be precise, the gearbox 4 is connected to an output shaft 5 from the gas turbine 2 and an input shaft 6 to the generator 3. The gas turbine arrangement 1 also comprises a starter motor 7 which is connected to an output shaft 8 from the generator 3. Unlike conventional gas turbine arrangements, the generator 3 therefore has not only an input shaft 6, but also an output shaft 8 on another side of the generator relative to the gearbox 4.

To start the gas turbine arrangement, the gas turbine is accelerated by means of the starter motor 7 and a combustion chamber 15 forming part of the gas turbine 2 is then ignited. The starter motor 7 is then uncoupled from driving connection to the output shaft 8 from the generator 3.

The gas turbine 2 comprises a compressor part 13, a turbine part 14 and a combustion chamber 15 arranged therebetween. The turbine wheel is connected to the compressor wheel via an intermediate shaft 16. The exhaust gases from the combustion chamber 15 act on the blades of the turbine wheel, and this causes the turbine wheel to rotate. The turbine wheel drives the compressor wheel via the intermediate shaft 16 and in this way the air conducted into the combustion chamber 15 is compressed. An output shaft 5 connected to the compressor wheel forms an input shaft to the gearbox 4.

In the gearbox 4, the speed is geared down for the generator 3. In the generator 3, the mechanical rotational energy is converted into electrical energy.

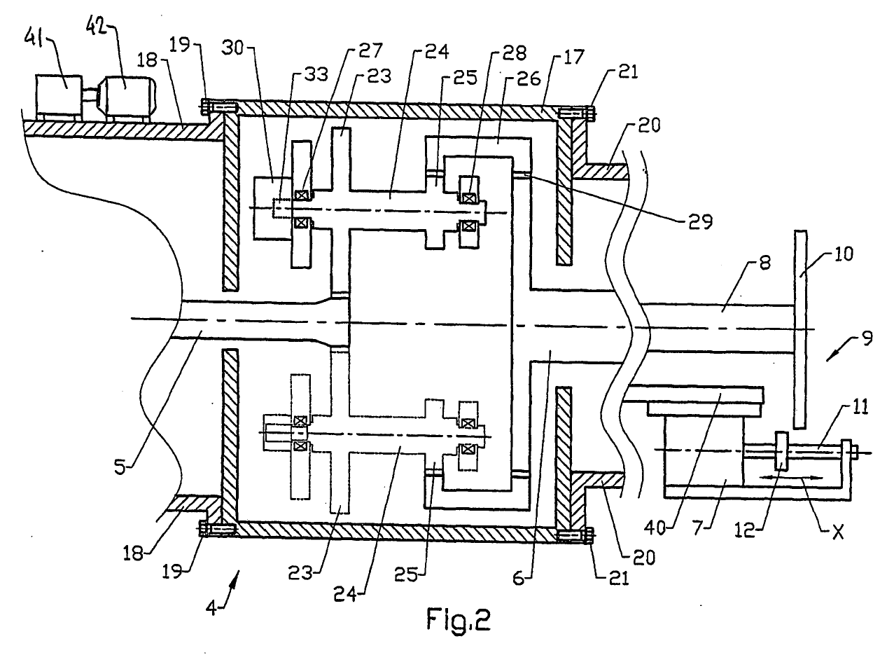

The gearbox 4 is connected to the gas turbine 2 on its compressor side. This is advantageous for several reasons; for example, the temperature during operation of the arrangement is lower than on the turbine side of the gas turbine. This leads to the possibility for the gearbox 4 to be connected directly to the gas turbine 2 by means of flange connection of their housings (see FIG. 2) which affords opportunities for a compact arrangement in the axial direction. To be precise, the housing 17 of the gearbox 4 is connected directly to the housing 18 of the gas turbine 2 by means of screw joints 19. The housing 17 of the gearbox 2 is also connected directly to the housing 20 of the generator 3 by means of screw joints 21. By virtue of the positioning of the gearbox 4 on the compressor side of the gas turbine 2, exhaust gases from the gas turbine can moreover be conducted in a simple manner.

FIG. 2 shows a first example of the connection of the starter motor 7 to the output shaft 8 of the generator 3. Here, the starter motor 7 is connected to the output shaft 8 via a coupling device in the form of a gear transmission 9. The gear transmission 9 comprises a first gearwheel, in the form of a flywheel 10, arranged on the shaft 8, and a second gearwheel, in the form a displaceable pinion 12, assigned to a shaft 11 of the starter motor 7. The pinion 12 can be displaced in the axial direction (see the arrows with the reference X) in order to be brought into and out of engagement with the flywheel 10. Such a coupling is previously known per se and therefore will not be described here in greater detail. When coupling-in of the starter motor 7 is desired, the pinion 12 is first caused to be displaced into engagement with the flywheel 10, after which the starter motor 7 is activated. Such sequential operation is suitably brought about by an electric circuit. When the combustion chamber has started running and the pinion 12 is no longer driving (or at a given speed), the pinion is displaced out of engagement with the flywheel 10, and the starter motor is switched off. In this way, coupling-in and uncoupling of the starter motor 7 can be brought about. The casing of the starter motor 7 is in turn connected rigidly to the housing 20 of the generator 3 via a bracket 40. The generator itself is not shown in FIG. 2.

According to the first embodiment, the starter motor 7 is of a type which allows the setting of different speeds. This is particularly advantageous when use is made of fuel in gaseous form, such as natural gas, as there are often provisions that the gas turbine be ventilated before each start, which means that the rotating parts of the gas turbine are to be rotated at a low speed which is known as ventilation speed. After ventilation has been completed, the gas turbine is started, and use is then made of a considerably higher speed.

FIG. 2 shows an example of the construction of the gearbox 4. The gearbox is of the planetary gear type with a stationary planet wheel carrier. The input shaft 5 to the gearbox 4 (that is to say, the output shaft from the gas turbine) is, via tooth meshing, connected to a number of first planet wheels 23. Each of the first planet wheels 23 is arranged rigidly on a planet wheel shaft 24 which also has a second planet wheel 25.

The second planet wheel has, via tooth meshing, a driving connection to a ring gear 26. The planet wheel shaft 24 is mounted in two bearing arrangements 27, 28.

The first planet wheel 23 has a greater diameter than the second planet wheel 25. By virtue of this arrangement, an extra gear stage is brought about before the ring gear 26. The ring gear 26 in turn has, via tooth meshing 29, a driving connection to the output shaft 6 from the gearbox 4. An auxiliary apparatus 30, for example an oil pump, is connected directly to the planet wheel shaft 24. A rotating component 33 in the auxiliary apparatus is indicated diagrammatically by a dotted line. Here, the rotating component in the auxiliary apparatus forms an extension of the planet wheel shaft.

FIG. 2 shows another way of driving an auxiliary apparatus 41, such as an oil pump, namely by means of an external energy source 42 such as an electric motor.

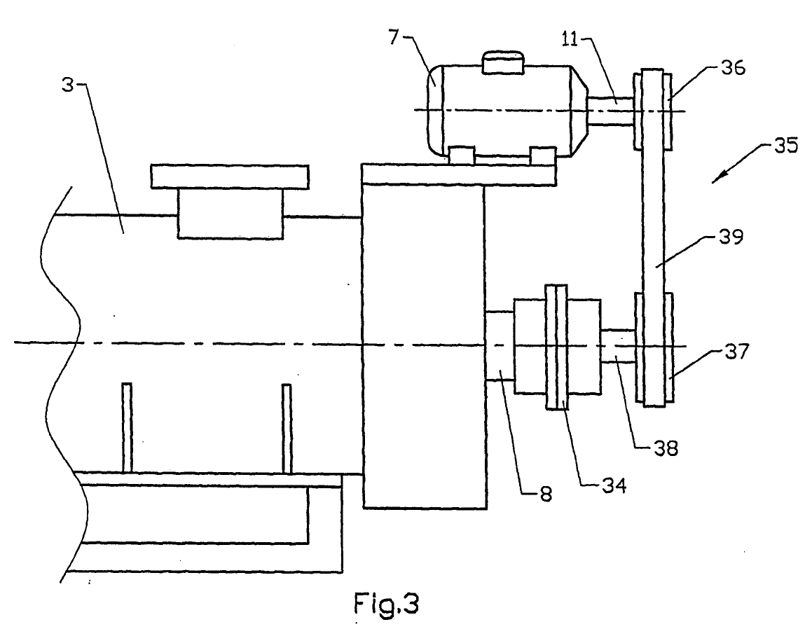

FIG. 3 shows an alternative to the arrangement depicted in FIG. 2 for coupling-in and uncoupling the starter motor 7. Here, the gas turbine arrangement 1 comprises a coupling device, in the form of a clutch 34, arranged on the output shaft 8 from the generator 3. This clutch 34 can be of a number of various types, for example of the automatic type; that is to say, of such a kind that it automatically uncouples the starter motor when a part coupled to the output shaft of the generator rotates more rapidly than a part coupled to the starter motor. In other words, the starter motor is uncoupled when the combustion chamber has started running and begun driving. Such clutches of the overrunning type are previously well known and are therefore not described here in detail.

In FIG. 3, the starter motor 7 is connected to the output shaft 8 from the generator 3 via a belt connection 35. A first belt wheel 37 is arranged on an output shaft 38 from the clutch 34 and on an opposite side of the clutch 34 relative to the generator 3. A second belt wheel 36 is arranged on a shaft 11 of the starter motor 7, and a belt 39 extends around the belt wheels 36, 37 for transmitting energy from the starter motor 7 to the gas turbine. According to an alternative to the belt connection, use is made of a chain transmission.

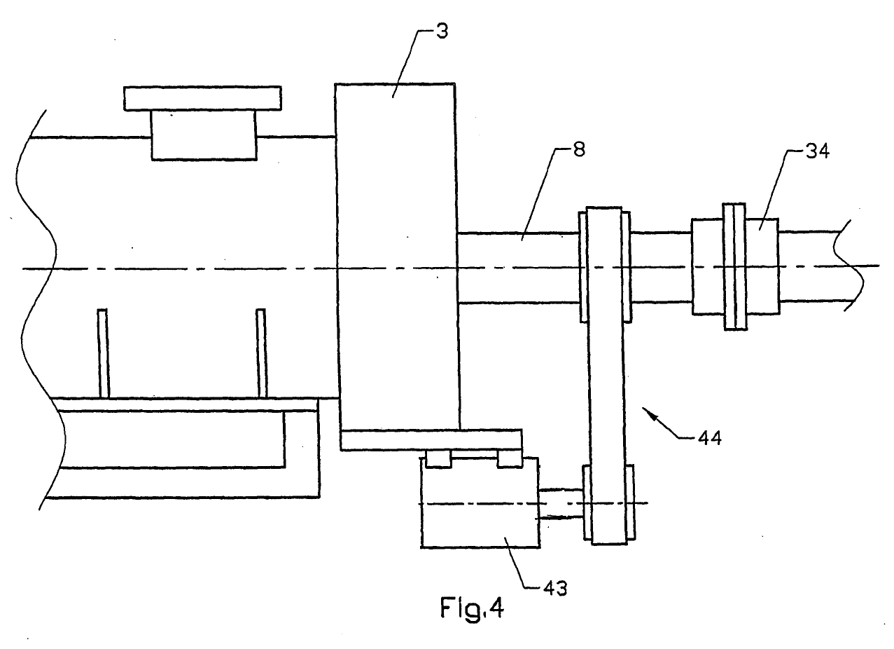

FIG. 4 shows another example of driving an auxiliary apparatus 43, such as an oil pump, which is a development (variation) of the embodiment depicted in FIG. 3. In this case, the auxiliary apparatus is connected to the output shaft 8 from the generator 3 between the generator and the coupling device. In this way, the auxiliary apparatus will be driven by the gas turbine even when the starter motor is uncoupled from driving connection to the generator. To be precise, the auxiliary apparatus is connected to the output shaft via a belt connection 44. This further example of auxiliary apparatus driving can of course also be used in the embodiment according to FIG. 2.

When liquid fuel, such as diesel, is used, ventilation is not usually required (see above). This means that the starter motor can be of a relatively simple type without a speed-setting function; this in turn results in a cost-effective solution.

In addition to the starter motor, the gas turbine arrangement comprises other auxiliary apparatuses such as oil pump, fuel pump, rotating oil separator and compressors.

The planetary gearbox shown in FIG. 2 is to be regarded only as an example of how the planetary gear can be constructed for driving the auxiliary apparatus.

According to at least one alternative, each of the planet wheel shafts can be provided with only one planet wheel.

Furthermore, a number of the planet wheel shafts can each drive an auxiliary apparatus. According to another example, a planet wheel shaft can drive two or more auxiliary apparatuses. Two auxiliary apparatuses can then, for example, be arranged at two opposite ends of one and the same planet wheel shaft.

The invention is not to be regarded as being limited to the embodiments described above, but a number of other variants and modifications are conceivable within the scope of the following patent claims. For example, the shaft 11 of the starter motor can be connected directly to the output shaft 8 from the generator 3 via the clutch 34.

Furthermore, use can be made of planetary gearboxes other than that described above, such as a planetary gearbox with a stationary ring gear in which the planet carrier is connected to the output shaft.

The planetary gearbox described above is moreover to be regarded only as an example of the gearbox type, and other types are conceivable within the scope of the patent claims. For example, the gearbox can be of at type that is known as a parallel shaft type; that is to say, having an input shaft and an output shaft, arranged in line with one another, and an intermediate shaft arranged parallel to and with a driving connection to these.

One possible application of the gas turbine arrangement described above is as a propulsion unit for a vehicle with electric motor drive. The generator is then connected to an electric motor which is in turn connected to the drive shaft of the vehicle for driving the shaft. An energy storage means, such as an accumulator, can also be connected to the generator and the electric motor so as in certain operating states to store energy and in other operating states to supply stored energy.

1. A gas turbine arrangement (1) comprising: a gas turbine (2); a generator (3); a gearbox (4) connected to an output shaft (5) from the gas turbine (2) and an input shaft (6) to the generator (3); and a starter motor (7) connected to an output shaft (8) from the generator (3).

2. The gas turbine arrangement as recited in claim 1, further comprising: a coupling device (9, 34) between the generator and the starter motor configured for coupling-in, and uncoupling the starter motor (7).

3. The gas turbine arrangement as recited in claim 2, wherein the coupling device (9, 34) has a capacity for automatic uncoupling.

4. The gas turbine arrangement as recited in claim 2, further comprising: a gearwheel transmission arranged between the starter motor (7) and the output shaft (8) from the generator (3); the coupling device (9) comprising a first (12) gearwheel in the transmission that is axially displaceable relative to a second gearwheel, said first and second gearwheels being engageable with one another.

5. The gas turbine arrangement as recited in claim 2, wherein the coupling device (9, 34) consists of a clutch (34).

6. The gas turbine arrangement as recited in claim 1, wherein the starter motor (7) is connected to the output shaft (8) of the generator (3) via a chain transmission.

7. The gas turbine arrangement as recited in claim 1, wherein the starter motor (7) is connected to the output shaft (8) of the generator (3) via a belt transmission (35).

8. The gas turbine arrangement as recited in claim 1, wherein the speed of the starter motor (7) is adjustable.

9. The gas turbine arrangement as recited in claim 1, further comprising: at least one auxiliary apparatus (41) which, for driving, is connected to an external energy source (42).

10. The gas turbine arrangement as recited in claim 1, wherein the gearbox (4) consists of a planetary gearbox.

11. The gas turbine arrangement as recited in claim 10, further comprising: at least one auxiliary apparatus (30) which, for driving, is connected to a planet wheel shaft (24) of the planetary gearbox (4).

12. The gas turbine arrangement as recited in claim 1, further comprising: at least one auxiliary apparatus (43) which, for driving, is connected to the output shaft from the generator.

13. The gas turbine arrangement as recited in claim 1, wherein the gas turbine arrangement (1) is a stationary arrangement for electricity production.
